(19) United States
(12) Patent Application Publication
(10) Pub. No.: US 2011/0174721 A1
(43) Pub. Date: Jul. 21, 2011

(54) FILTER WITH QUICK DISASSEMBLY MECHANISM

(76) Inventor: Shui-Tien Horng, Kaohsiung City (TW)

(21) Appl. No.: 12/883,180

(22) Filed: Sep. 16, 2010

(30) Foreign Application Priority Data
Jan. 15, 2010 (TW) 099200863

(51) Int. Cl. B01D 29/085

(52) U.S. Cl. 210/474

(57) ABSTRACT

A filter with quick disassembly mechanism includes a hollow cylinder having an open top and an open bottom, the cylinder comprising a lower extension including a plurality of flanges equally spaced apart along an outer surface, each flange having an inclined top surface; and a funnel comprising a mouth adapted to receive the cylinder, a hollow stem extending downward and communicating with the mouth, a plurality of stop members equally spaced apart along an annular edge of an inner surface of the mouth, an annular platform projecting inward from the mouth to be adapted to support the cylinder, a plurality of gaps each defined between the stop member and the platform, the height of each gap being greater than one end of the flange but less than the other end of the flange. Clockwise turning the cylinder a predetermined angle will assemble the cylinder and the funnel.

### BACKGROUND OF THE INVENTION

1. Field of Invention

The invention relates to filters and more particularly to a filter (e.g., filter funnel) having a mechanism to enable an individual to quickly either assemble a cylinder and a funnel or disassemble same.

2. Description of Related Art

Filtration is a process of separating solids from liquids and is widely employed in laboratories and industries including pharmaceuticals, food, water, etc. Specifically, filtration can be used for suspended solid separation, HPLC (high performance liquid chromatography), GC (gas chromatography), and AAS (atomic absorption spectroscopy).

A typical filtration with respect to a filter funnel is detailed below. Filtration material (e.g., filter paper) is placed on a plate. The filter paper is moistened with a solvent to prevent initial leakage. The liquid to be filtered is poured into a cylinder and drawn through a perforated plate in the cylinder by vacuum suction. The main advantage in using the filtration is that it proceeds much more quickly (several orders of magnitude) than simply allowing the solvent to drain through the filter medium via the force of gravity.

Coupling means of the typical filter funnel is a retaining ring which is adapted to secure the cylinder to the funnel by clamping. However, it tends to break at the joining portion of the cylinder and the funnel.

Another coupling means of the typical filter funnel is threading. That is, for example, male threads of the cylinder are secured to female threads of the funnel. However, a number of thread turning of the cylinder or the funnel is required for fastening them together (i.e., not time saving). Further, the fastening portion may jam (i.e., not easy of disassembly). Thus, the need for improvement still exists.

### SUMMARY OF THE INVENTION

It is therefore one object of the invention to provide a filter having a mechanism to enable an individual to quickly either assemble a cylinder and a funnel or disassemble same.

To achieve the above and other objects, the invention provides a filter comprising a hollow cylinder having an open top and an open bottom, the cylinder comprising a lower extension including a plurality of flanges equally spaced apart along an outer surface, each flange having an inclined top surface; and a funnel comprising a mouth adapted to receive the cylinder, a hollow stem extending downward and communicating with the mouth, a plurality of stop members equally spaced apart along an annular edge of an inner surface of the mouth, an annular platform projecting inward from the mouth to be adapted to support the cylinder, a plurality of gaps each defined between the stop member and the platform, the height of each gap being greater than one end of the flange but less than the other end of the flange, whereby clockwise turning the cylinder in the mouth a predetermined angle will assemble the cylinder and the funnel by partially inserting the flanges into the gaps.

The above and other objects, features and advantages of the invention will become apparent from the following detailed description taken with the accompanying drawings.

### BRIEF DESCRIPTION OF THE DRAWINGS

FIG. 1 is a perspective view of a filter according to the invention;

FIG. 2 is an exploded view of the filter;

FIG. 3 is an elevational view of the filter; and

FIG. 4 is a partially broken away view showing a fastening operation of the cylinder and the funnel by turning the cylinder.

### DETAILED DESCRIPTION OF THE INVENTION

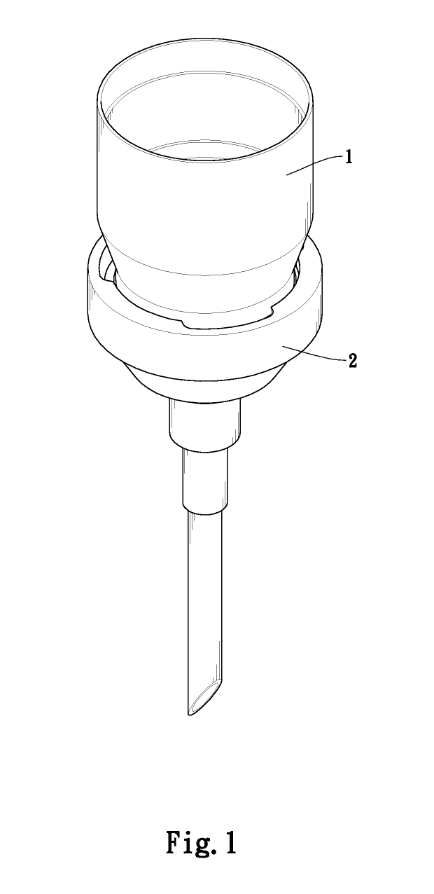

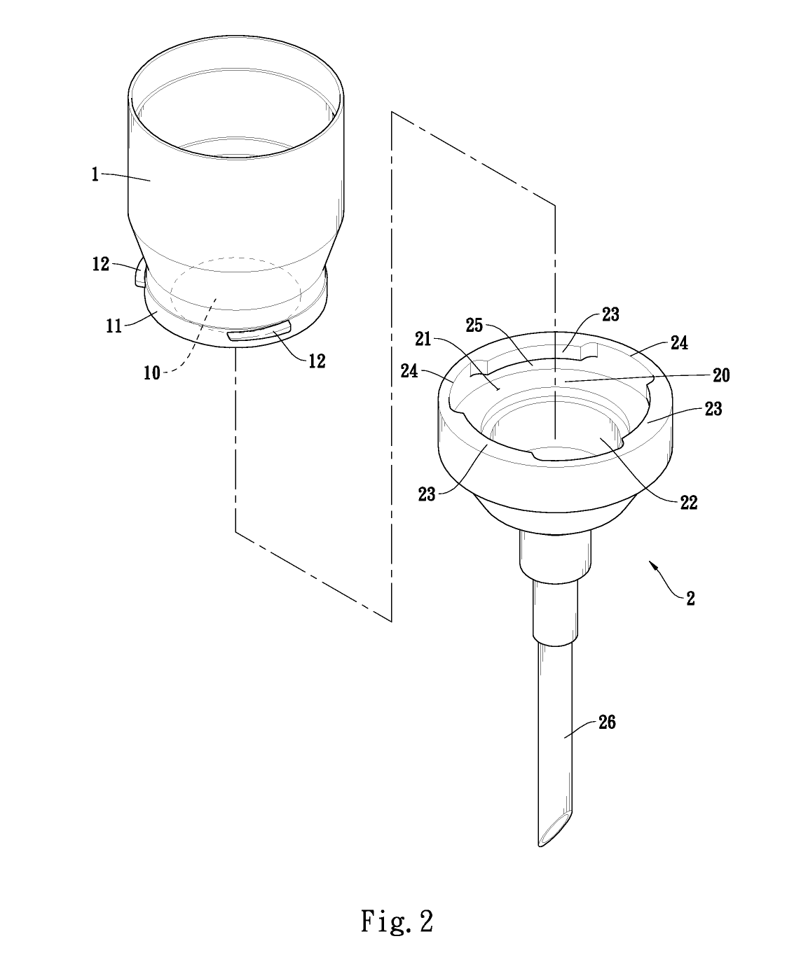

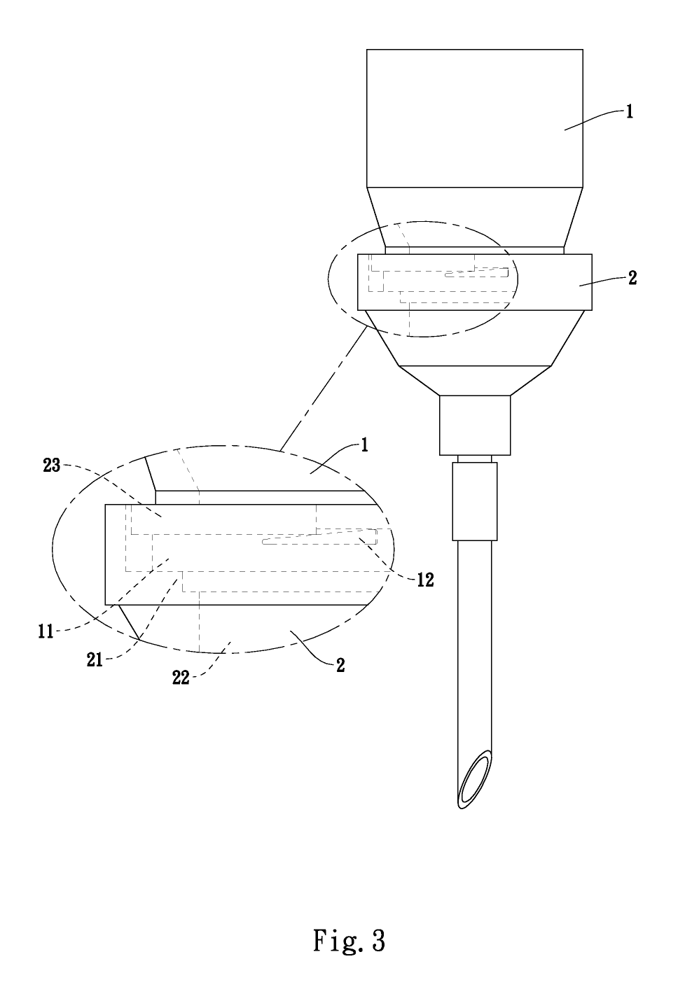

Referring to FIGS. 1 to 4, a filter in accordance with the invention comprises an upper cylinder 1 and a lower funnel 2 each will be discussed in detail below.

The cylinder 1 is hollow and has an open top and an open bottom 10. The cylinder 1 comprises an extension 11 on a lower end of a lower tapered portion, and a plurality of (e.g., three) flanges 12 equally spaced apart along the periphery of the extension 11. The flange 12 is slightly arc-shaped and has an inclined top surface from one end to the other end.

The funnel 2 comprises a hollow stem 26, a wide mouth 24, an upper space 20 defined by the mouth 24, a channel 22 extending from the space 20 through the stem 26, a plurality of (e.g., three) arc-shaped stop members 23 equally spaced apart along an annular edge of an inner surface of the space 20, an annular platform 21 projecting inward from the mouth 24 to dispose between the space 20 and the channel 22, and a plurality of (e.g., three) gaps 25 each defined between the upper stop member 23 and the lower platform 21.

The diameter of a virtual circle formed by the stop members 23 is slightly greater than the outer diameter of the extension 11. Further, height of the gap 25 is greater than one end of the flange 12 but less than the other end of the flange 12.

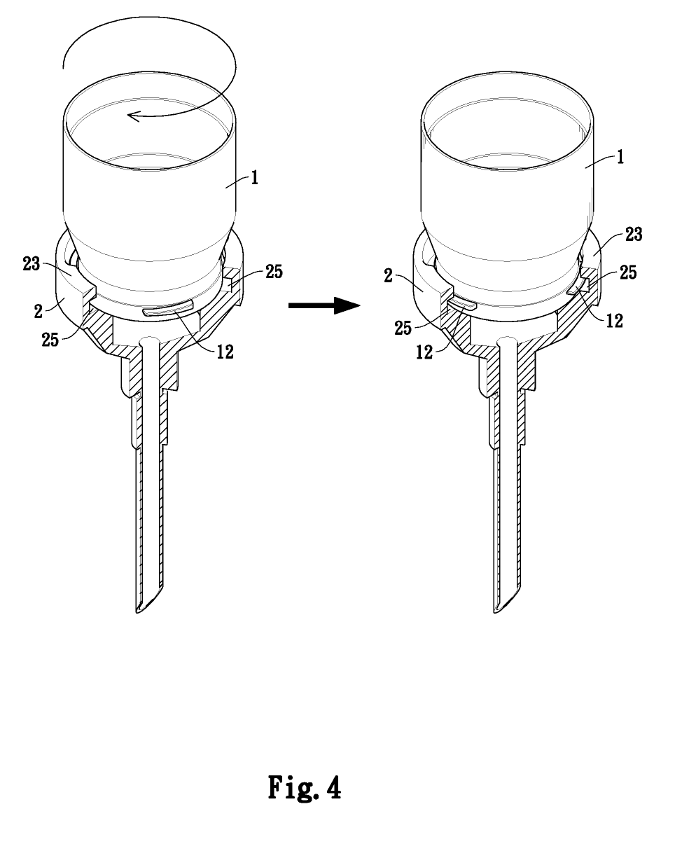

A fastening operation of the cylinder 1 and the funnel 2 will be described in detailed below. As shown in left side of FIG. 4, first align each flange 12 with a recess (not numbered) between any two adjacent stop members 23. Next, place the extension 11 in the mouth 24 (i.e., the space 20) until the bottom of the extension 11 is stopped by the platform 21. Next, clockwise turn the cylinder 1 with one hand and hold the funnel 2 with the other hand.

As shown in right side of FIG. 4, each flange 12 may enter the gap 25 until, preferably, an intermediate portion of the flange 12 contacts the gap 25 (i.e., stopped by the gap 25). The flanges 12 are thus partially fastened in the gaps 25. As a result, the cylinder 1 and the funnel 2 are fastened together. It is understood that a reverse operation of the above paragraph can detach the filter.

Advantages and characteristics of the invention are described below. The assembly of the filter is quick and reliable. Further, a disassembly of the filter is quick.

While the invention has been described in terms of preferred embodiments, those skilled in the art will recognize that the invention can be practiced with modifications within the spirit and scope of the appended claims.

What is claimed is:

1. A filter comprising:
a hollow cylinder having an open top and an open bottom, the cylinder comprising a lower extension including a plurality of flanges equally spaced apart along an outer surface, each flange having an inclined top surface; and
a funnel comprising a mouth adapted to receive the cylinder, a hollow stem extending downward and communicating with the mouth, a plurality of stop members equally spaced apart along an annular edge of an inner surface of the mouth, an annular platform projecting inward from the mouth to be adapted to support the cylinder, a plurality of gaps each defined between the stop member and the platform, the height of each gap being greater than one end of the flange but less than the other end of the flange so as to secure to the flange when the flange is inserted in the gap.

2. The filter of claim 1, wherein the height of an intermediate portion of the flange is equal to that of the gap.
